(19) United States
(12) Patent Application Publication
(10) Pub. No.: US 2021/0061698 A1
(43) Pub. Date: Mar. 4, 2021

(54) METHOD FOR STRENGTHENING AND BENDING GLASS SHEETS

(71) Applicant: AGP America S.A., Ciudad de Panama, PA (US)

(72) Inventors: Mario Arturo MANNHEIM ASTETE, Lima (PE); Ivan Arturo CORNEJO, Lima (PE); Mauricio Fernando CORNEJO POL, Lima (PE)

(73) Assignee: AGP America S.A., Ciudad de Panama (PA)

(21) Appl. No.: 16/958,663

(22) PCT Filed: Dec. 22, 2018
(86) PCT No.: PCT/IB2018/060552

§ 371 Date: Jun. 26, 2020

Related U.S. Application Data
(60) Provisional application No. 62/610,755, filed on Dec. 27, 2017.

(30) Foreign Application Priority Data
Feb. 8, 2018 (CO) NC2018/0001322

(51) Int. Cl. C03B 23/025; C03B 23/03; C03C 21/00; C03C 23/00; C03C 27/06

(52) U.S. Cl. CPC C03B 23/0252; C03B 23/0302; C03C 27/06; C03C 23/007; C03C 21/008

(57) ABSTRACT

Method for strengthening and bending glass sheets, wherein a saturated saline solution is applied to glass sheets, followed by a rapid temperature change, allowing the salt to 5 precipitate. The glass sheets are then evenly coated with a recrystallized salt. Subsequently, the glass sheets are ion exchanged and bent at a predetermined temperature for a predetermined period of time.

### FIELD OF THE INVENTION

The present disclosed invention relates to a method for strengthening and bending glass sheets in a single step, and more particularly to a method for strengthening glass sheet by ion exchange using saturated solutions during bending process.

### BACKGROUND OF THE INVENTION

During glass manufacturing, several processes have to be performed in a specific sequence in order to obtain a desired result. Some of these processes are bending process and ion exchange process. In the bending process, a glass sheet is bent in order to adopt a specific permanent shape by using a bending technique such as gravity bending, press bending or hot bending.

The gravity bending technique is a bending process in which the glass sheet is gradually heated in a furnace above its deformation point and where the force of gravity acts on the glass sheet, causing to sag under its own weight onto a concave or convex mold placed horizontally in the furnace. Similarly, the press bending technique is a bending process in which the glass sheet is gradually heated in a furnace above its strain point while compression forces are applied to the glass sheet by press members having complementary surfaces corresponding to the desired shape. In both techniques, after the desired shape is obtained, the glass sheet is cooled in a controlled manner.

Regarding the ion exchange process, it is performed after the glass is made into the final product, wherein smaller ions in the glass composition (e.g. sodium ions) are substituted with larger ions in a molten ionic salt (e.g. potassium ions) in order to improved/modified some properties in the surface of the glass sheet, such as strength. The ion exchange process creates a thin layer of high compression on the surface which results in a layer of maximum tension at the center. Conventional ion exchange technique is performed by submerging the glass sheet into an ionic bath for several hours at temperatures usually below the strain point of the glass. This technique is widely used today to strengthen glass sheets that are used in mobile phones, televisions, automobiles, etc. In order to make this process manufacturable, large quantities of salt are melted in large stainless-steel vessels, where the glass sheets are ion exchanged following a specific temperature/time recipe, i.e. the ionic bath with the glass sheets inside must be heating at a predetermined temperature T during a predetermined period of time t.

For example, in a production process of chemically strengthened soda-lime glass sheets, according to the conventional ion exchange technique, an ionic bath composition is prepared into a vessel by melting ionic salt KNO₃ with heat. Next, the glass sheets are preheated at 350° C. inside a furnace for two hours, and the temperature of the ionic bath composition prepared is adjusted to about 450° C. for chemical strengthening, wherein the glass sheets preheating temperature depends on the temperature at which the glass sheets will be immersed in the ionic bath. Next, the glass sheets are immersed in the ionic bath composition for eight to twelve hours to allow the ion exchange to take place. Finally, the glass sheets are removed from the vessel to cool them gradually to room temperature inside a furnace for three hours.

Usually, a laminated glass production process requires both bending process and ion exchange process in order to combine two or more glass sheets with at least one sheet interlayer material that keeps the glass sheets bonded even when broken. In this process, after cutting the glass sheets to a desired size and/or shape, the glass sheets are curved simultaneously by a bending process (for about ten minutes). Next, the glass sheets are chemically strengthened according to the conventional ion exchange technique (for thirteen to eighteen hours). Then, the glass sheets are cleaned and, finally, the glass sheets are laminated together.

As can be noted, the processes are performed sequentially, and the ion exchange process is the most time-consuming process that consumes a considerable amount of energy not only because of the preheating and heating steps, which last several hours, but also because of the bath preparation step. It is especially significant when different types of glasses are needed, each type of glass requiring different ionic bath compositions. Thus, between the processing of two different types of glasses, it is required to remove the current ionic bath composition from the vessel, clean the vessel and reload the vessel with the appropriate ionic bath composition, which can take several days. Therefore, the ionic exchange process becomes the bottle neck of the entire production chain.

Another problem with this conventional technique is that the process is potentially dangerous for the following reasons: (a) it produces large amounts of nitrogen oxides (NOx) because of the decomposition of the salt at the high temperature during the long heating periods; (b) the salt can react violently with water at high temperature (e.g. a badly dried glass); and (c) the rate of vessel corrosion is elevated because of the high salt concentration. Another problem that arises with conventional technique is the salt cross contamination, i.e. as the salt is continuously used, the bath is progressively enriched with the original ions from the glass. The rate of ion exchange tends to decrease, and so does the compressive stress. At some point, the salt must be changed.

As a partial solution to those problems, some research has proposed methods of strengthening glass, wherein an aqueous solution containing at least one ionic salt is used to provide a film on the glass surface before heat treating. For example, U.S. Pat. No. 3,498,773 uses an aqueous solution that changes its salt to water concentration due to the vaporization of water to provide a solid film on a glass surface, while U.S. Pat. No. 4,206,253 uses an aqueous solution containing a surfactant and potassium salts, wherein the temperature of the aqueous solution is greater than that of the glass, thereby depositing out the potassium salts on the surface of the glass.

However, both mentioned methods have restrictions on saturated solutions and types of glasses that can be used, in part due to the target application (bottle manufacturing). Furthermore, none of the methods describe how to optimize the production process of glass in which bending and ion exchange processes are required.

Consequently, there is a need in the art for methods for strengthening glass sheets that be broad in application scope and optimize the use of resources in glass production.

### SUMMARY OF THE INVENTION

It is an object of the present invention to provide a method for strengthening glass sheets, which is used during re-forming glass sheets in order to decrease the process time, the energy consumption and the amount of salt used. Furthermore, it is an object of the invention to provide a method which has no restriction on saturated solution and types of glasses being used. Moreover, it is an object of the present invention to improve extra glass surface properties in addition to strength.

These objects can be attained by a method for strengthening a glass sheet while bending thereof, which comprises the steps of applying a saturated solution at temperature T₁ on the glass sheet at temperature T₂, wherein the saturated solution contains an ionic salt and a liquid solvent, and wherein T₁>T₂; allowing the solution on the glass sheet to cool, thereby precipitating the ionic salt as soon as the solution temperature decrease, leaving a crust of salt adhered to the surface of the glass sheet; heating the glass sheet at a predetermined temperature T₃ for a predetermined period of time t₃ for bending it by a bending process, wherein the temperature T₃ ranges from the temperature at which the viscosity of the glass sheet is 10^{14.6} poises to the temperature at which the viscosity of the glass sheet is 10^{7.6} poises, and the time t₃ is enough to impart a selected permanent curvature to the glass sheet; and cooling the glass sheet.

As can be noted, in the case of a saturated solution as the method described above, not as much salt is required as in the case of the conventional ion exchange method where a molten salt is needed. Additionally, since the ion exchange does not occur inside a container with the ionic solution, said solution does not become contaminated. Thus, the salt remaining in the saturated solution can be re-used efficiently for next ionic salt coatings and exchange processes. Furthermore, as the glass sheet does not require to be preheated prior to solution application and the heating step lasts much less than that of the conventional ion exchange method, time and energy consumed are improved significantly.

Also, as the saturated solution is prepared as it is needed and the heating time is reduced considerably, not as much NOx is produced as in other methods. In addition, since the solution is a saturated solution, there is no probability of salt reacting violently with water as in the conventional method. Moreover, when different types of saturated solutions are needed, each of them can be prepared in a short time, even a previous saturated solution can be re-used to prepare new ones.

Finally, there is no particular limitation on the ionic salt, solvent and type of glass that can be used in the present invention and, therefore, it is possible to modified others glass surface properties in addition to strength.

### BRIEF DESCRIPTION OF THE DRAWINGS

These features and advantages of the present invention will become apparent from the detailed description of the following embodiments in conjunction with the accompanying drawings, wherein:

FIG. 1 shows a saturated solution application process according to one embodiment of the present invention.

FIG. 2 shows an embodiment of the present invention wherein the bending process is carried out by the gravity bending technique.

FIG. 3 shows an embodiment of the present invention wherein the bending process is carried out by the press bending technique.

FIG. 4 shows a first example of a glass package configuration according to one embodiment of the present invention.

FIG. 5 shows a second example of a glass package configuration according to one embodiment of the present invention.

### DETAILED DESCRIPTION OF THE INVENTION

Referring now to the drawings, there are shown preferred embodiments of the method according to the present invention.

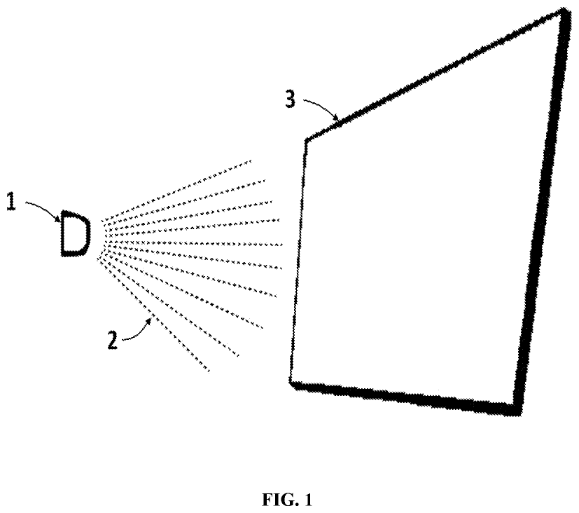

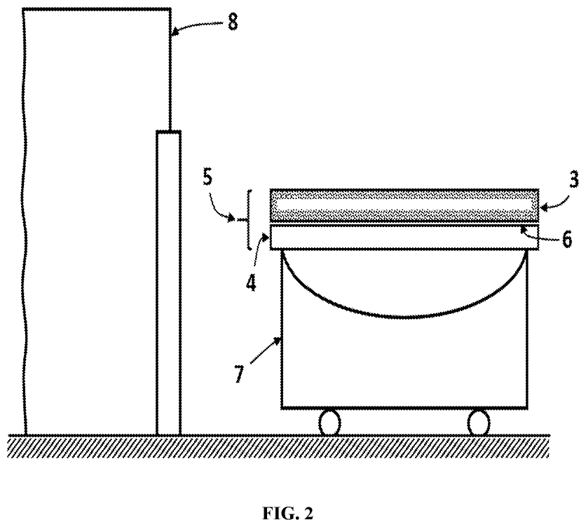

FIG. 1 shows spray means 1 applying a saturated solution 2 on a glass sheet 3. The saturated solution 2 is previously prepared by dissolving ionic salt in a liquid solvent (e.g. deionized water) at a temperature T₁, wherein the solubility of the salt is higher as T1 increases according to the solubility curve of said salt which plots the changes of the solubility of a salt at different temperatures in a solvent. The ionic salt is a salt with the generic formula ANO₃, or a mixed ionic salt (A, B)NO₃, or a mixture thereof; wherein both A and B are an alkali metal (e.g. NaNO₃, KNO₃ and LiNO₃, among others). The saturated solution 2 at temperature T₁ is applied on the glass sheet 3 at temperature T₂, wherein T₁ is greater than T₂. Next, the solution 2 on the glass sheet 3 is allowed to cool at a cooling rate from 1° C./min to 100° C./min, preferably from 1° C./min to 50° C./min, thereby precipitating the ionic salt as soon as the solution temperature decrease along the solubility curve of said ionic salt, i.e. as temperature decreases it precipitates as much ionic salt as corresponds to the change of temperature at the curve. As a result, the glass sheet 3 is evenly coated with a recrystallized salt, forming a crust of salt on the surface of the glass sheet 3. Next, the glass sheet 3 is heated inside a heat source 8 (FIG. 2) at a predetermined temperature T₃ for a predetermined period of time t₃ for bending it by a bending process, wherein the temperature T₃ ranges from the temperature at which the viscosity of the glass sheet is 10^{14.6} poises to the temperature at which the viscosity of the glass sheet is 10^{7.6} poises, and the time t₃ is enough to impart a selected permanent curvature to the glass sheet 3. Lastly, the glass sheet 3 is cooled inside the heat source in a controlled manner, preventing the glass sheet from shattering due to sudden temperature change.

FIG. 2 shows an embodiment wherein the bending process is carried out by the gravity bending technique. In this technique, between the step of allowing the solution on the glass sheet to cool and the step of heating the glass sheet, an additional glass sheet 4 is positioned below the glass sheet 3, forming a glass package 5, so that the crust of salt on the bottom surface 6 of the glass sheet 3 is retained in contact with said bottom surface 6 during the heating step. The glass package 5 is supported on a bending mold 7, and then placed in the heat source 8 for performing the heating step, wherein the force of gravity acts on the glass package 5, causing to sag under its own weight onto the bending mold 7.

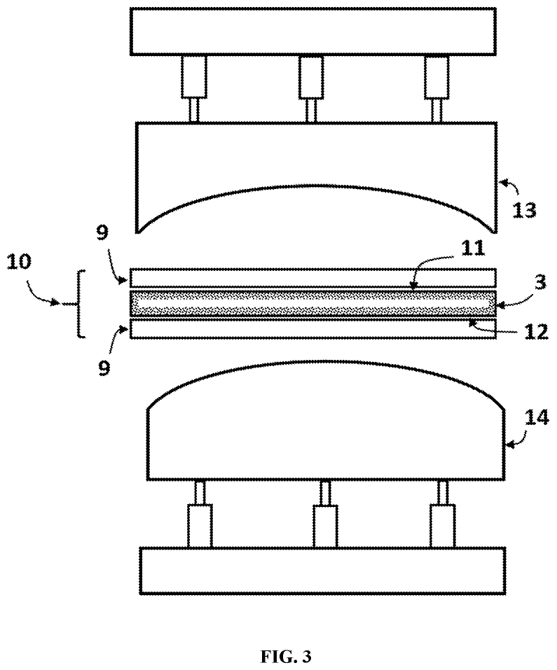

FIG. 3 shows an embodiment wherein the bending process is carried out by the press bending technique. In this technique, between the step of allowing the solution on the glass sheet to cool and the step of heating the glass sheet, the glass sheet 3 is sandwiched between two additional glass sheets 9, forming a glass package 10, so that the crust of salt on both top 11 and bottom 12 surfaces of the glass sheet 3 is retained in contact with said surfaces 11-12 during the heating step. The glass package 10 is heated inside a heat source and then compression forces are applied to it by press members 13-14 having complementary surfaces corresponding to the desired shape.

In certain applications, wherein it is required to bend two or more glass sheets simultaneously (e.g. production process of a laminated glass), the glass sheets are disposed one above the other, forming a glass package. Thus, depending on the glass package configuration, some of these glass sheets can be used as additional glass sheets. For example, according to the present invention, in a production process of two laminated glass, wherein the selected bending technique is gravitational bending, and the required laminated glass has the follow composition:

Laminated glass I: a chemically strengthened alkali aluminosilicate glass sheet and a borosilicate glass sheet; and

Laminated glass II: two chemically strengthened alkali aluminosilicate glass sheets;

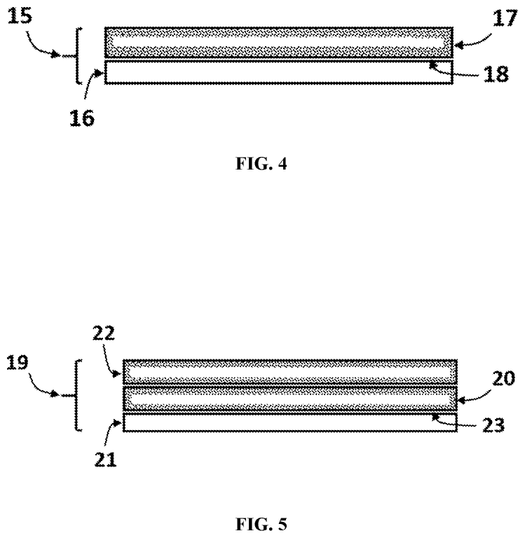

the glass package 15, in the former case, comprises a borosilicate glass sheet 16 at the bottom and an alkali aluminosilicate glass sheet 17 at the top (FIG. 4), wherein the alkali aluminosilicate glass sheet 17 has a crust of salt adhered to its surface, so that the borosilicate glass sheet 16 acts as an additional glass sheet, which retains in contact the crust of salt on the bottom surface 18 of the alkali aluminosilicate glass sheet 17 with said surface 18 during the heating step.

In the latter case, the glass package 19 comprises an alkali aluminosilicate glass sheet 20 sandwiched by a sacrificial glass sheet 21 (e.g. borosilicate glass sheet) at the bottom and an alkali aluminosilicate glass sheet 22 at the top (FIG. 5), wherein both alkali aluminosilicate glass sheets 20, 22 have a crust of salt adhered to their surface. Despite not being part of the laminated glass composition, the sacrificial glass sheet 21 is required as an additional glass sheet during the heating step in order to retain in contact the crust of salt on the bottom surface 23 of the sandwiched alkali aluminosilicate glass sheet 20 with said surface 23.

In the embodiments depicted in FIGS. 1-5, the heat source is a furnace. In all embodiments, the heat source is provided with at least one heat transfer mechanism selected from the group consisting of convection, radiation and conduction.

Moreover, in the embodiments depicted in FIGS. 1-5, the thickness of the crust lies between 10 and 60 μm. However, in other embodiments, the thickness of the crust lies between 10 and 600 μm, preferably between 10 and 400 μm, and even more preferably between 10 and 200 μm.

Additionally, in the embodiment illustrated in FIG. 1, the saturated solution is atomized on the glass sheet. However, in other embodiments, the saturated solution is applied to the glass sheet by others means. In an embodiment, the application step is performed by immersing the glass sheet in the saturated solution. In an alternative embodiment, the saturated solution is applied to glass sheet by painting the saturated solution via paint application means.

As can be noted, the present invention is not limited to a particular shape, geometry or size of the glass sheet. Furthermore, the invention can be used independently of the glass type and/or composition used, provided that the glass sheet contains alkalis or transition metals in its composition. Moreover, the present invention is able to take advantage of the chemical strengthening process to change others glass surface properties such as luminescence, index of refraction, antimicrobial properties and antibacterial properties, among others. Therefore, in the embodiments in which at least one of these properties are required, the ionic salt is a mixed ionic salt of the form (C, D)NO₃; wherein C is an alkali metal and D is selected from the group consisting of transition metals and rare-earth metals.

Alternatively, in some embodiments, the ionic salt contains at least one salt selected from the group consisting of sulfides, chlorides, halides or hydrates.

In several embodiments, the glass sheets are made of soda-lime, alkali aluminosilicate, lithium aluminosilicate, alkali alkaline earth aluminosilicate or another silicate.

In all embodiments, the liquid solvent is water or at least one organic solvent (e.g. ammonia and glycerol, among others). In some embodiments, wherein the liquid solvent is water, the liquid solvent is selected from the group consisting of deionized water, distilled water and potable water.

Although, only two bending techniques were exemplified herein, one of ordinary skill in the art would appreciate that the present invention can be performed with other well-known bending techniques (e.g. hybrid techniques).

Subsequently, a practical example will be set forth to clarify the effects of the present invention.

### EXAMPLE

A mixture of equal parts of KNO₃ and deionized water were mixed at 80° C. The saturated solution was painted with a brush on a cold alkali aluminosilicate glass sheet (AAS). The KNO₃ precipitated almost immediately after contacting the surface of the glass sheet. The painted glass sheet was then sandwiched by a soda-lime silicate glass sheet at the bottom and a borosilicate glass sheet at the top, forming a glass package. The glass package entered to a gravity forming furnace preset at 625° C. and hold it for 420 seconds. During this time, the glass package decreased the temperature to 576° C. After that, the furnace was allowed to cool down to about 300° C., before removing the curved glass. The total time of the glass package inside the furnace and above the melting point of KNO₃ was of 16 minutes. The result of the painted glass sheet is reported as follow:

TABLE 1

| | Compressive Stress—CS | Depth of Layer—DOL |
|---|---|---|
| Type of glass | (MPa) | (μm) |
| AAS | 507 | 20 |

In the example, the compressive strength and depth of layer values obtained (TABLE 1) are typically what have been reported in the literature for the conventional ion exchange method.

It must be understood that this invention is not limited to the embodiments described and illustrated above. A person skilled in the art will understand that numerous variations and/or modifications can be carried out that do not depart from the spirit of the invention, which is only defined by the following claims.

1. A method for strengthening a glass sheet while bending thereof, comprising the steps of:
applying a saturated solution at temperature T₁ on the glass sheet at temperature T₂, wherein the saturated solution contains an ionic salt and a liquid solvent, and wherein T₁>T₂;
allowing the solution on the glass sheet to cool, thereby precipitating the ionic salt as soon as the solution temperature decrease, leaving a crust of salt adhered to the surface of the glass sheet;
heating the glass sheet at a predetermined temperature T₃ for a predetermined period of time t₃ for bending it by a bending process, wherein the temperature T₃ ranges from the temperature at which the viscosity of the glass sheet is 10^{14.6} poises to the temperature at which the viscosity of the glass sheet is 10^{7.6} poises, and the time t₃ is enough to impart a selected permanent curvature to the glass sheet; and
cooling the glass sheet.

2. The method of claim 1, further comprising, between the step of allowing the solution on the glass sheet to cool and the step of heating the glass sheet, the steps of: providing at least an additional glass sheet; and positioning the glass sheet in contact with said at least additional glass sheet, so that the crust of salt on the surface of the glass sheet become trapped between the surfaces in contact during the heating step.

3. The method of claim 1, wherein the step of applying the saturated solution comprises: immersing the glass sheet in the saturated solution; and immediately extracting the glass sheet from said solution.

4. The method of claim 1, wherein the step of applying the saturated solution comprises atomizing the solution on the glass sheet via spray means.

5. The method of claim 1, wherein the step of applying the saturated solution comprises painting the solution on the glass sheet via paint application means.

6. The method of claim 1, wherein the steps of heating the glass sheet and cooling the glass sheet are carried out by a heat source with at least one heat transfer mechanism selected from the group consisting of convection, radiation and conduction.

7. The method of claim 1, wherein in the step of allowing the solution on glass sheet to cool, the cooling rate is from 1° C./min to 100° C./min, preferably from 1° C./min to 50° C./min.

8. The method of claim 1, wherein in the step of allowing the solution on the glass sheet to cool, the thickness of the crust lies between 10 and 600 μm, preferably between 10 and 400 μm, and even more preferably between 10 and 200 μm.

9. The method of claim 1, wherein the glass sheet is selected from the group consisting of soda-lime, alkali aluminosilicate, lithium aluminosilicate and alkali alkaline earth aluminosilicate.

10. The method of claim 1, wherein the ionic salt is selected from the group consisting of ionic salt of the form ANO₃, mixed ionic salt of the form (A, B)NO₃, and a mixture thereof; wherein both A and B are an alkali metal.

11. The method of claim 1, wherein the ionic salt is a mixed ionic salt of the form (C, D)NO₃; wherein C is an alkali metal and D is selected from the group consisting of transition metals and rare-earth metals.

12. The method of claim 1, wherein the ionic salt contains at least one salt selected from the group consisting of sulfides, chlorides, halides and hydrates.

13. The method of claim 1, wherein the liquid solvent is selected from the group consisting of water and at least one organic solvent.

14. The method of claim 1, wherein in the step of heating the glass sheet, the bending process is carried out by a technique selected from the group consisting of gravity bending, press bending and techniques that are hybrids thereof.

15. The method of claim 14, wherein the selected technique is gravity bending, and further comprising, between the step of allowing the solution on the glass sheet to cool and the step of heating the glass sheet, the steps of: providing an additional glass sheet; and positioning the glass sheet above the additional glass sheet, so that the crust of salt on the bottom surface of the glass sheet is retained in contact with said bottom surface of the glass sheet during the heating step.

16. The method of claim 14, wherein the selected technique is press bending, and further comprising, between the step of allowing the solution on the glass sheet to cool and the step of heating the glass sheet, the steps of: providing two additional glass sheets; and sandwiching the glass sheet between the additional glass sheets, so that the crust of salt on both top and bottom surfaces of the glass sheet is retained in contact with said surfaces of the glass sheet during the heating step.
